(19) United States
(12) Patent Application Publication
(10) Pub. No.: US 2004/0136775 A1
(43) Pub. Date: Jul. 15, 2004

(54) Tripod joint

(76) Inventor: Jung-Pin Chang, Taichung (TW)

Correspondence Address: Jung-Pin Chang, 58, MA YUAN WEST ST., TAICHUNG, TW

(21) Appl. No.: 10/346,633

(22) Filed: Jan. 15, 2003

(51) Int. Cl. F16D 1/12; F16C 11/00

(52) U.S. Cl. 403/64

(57) ABSTRACT

A tripod joint has a main body, a screw rod, a washer, and a butterfly nut. The main body has a periphery slot, three lugs, a plurality of inner periphery recesses, a circular hole communicating with the periphery slot, and a threaded hole communicating with the periphery slot to match the circular hole. The screw rod is inserted through the threaded hole and the circular hole of the main body. The washer surrounds the screw rod. The butterfly nut engages with the screw rod.

### BACKGROUND OF THE INVENTION

The present invention relates to a tripod joint. More particularly, the present invention relates to a tripod joint which positions a tripod device stably.

Referring to FIGS. 1 and 2, a tripod device has a pair of tripod joints 10′, a collar 50′, a center post 30′, three legs 20′, and three support bars 21′. The center post 30′ passes through the collar 50′ and the tripod joints 10′. One of the tripod joints 10′ receives the legs 20′. The collar 50′ engages with one of the tripod joints 10′ to be fastened by a stud 51′. The other of the tripod joints 10′ receives the support bars 21′. Each of the tripod joints 10′ has three lugs 11′. However, a dent will be formed on the center post 30′ while the stud 51′ is fastened very tight. Since the stud 51′ fastens the collar 50′ and one of the tripod joints 10′ with a single point, the collar 50′ is easily displaced.

### SUMMARY OF THE INVENTION

An object of the present invention is to provide a tripod joint which will not damage a center post of a tripod device.

Another object of the present invention is to provide a tripod joint which positions a tripod device stably.

Accordingly, a tripod joint comprises a main body, a screw rod, a washer, and a butterfly nut. The main body has a periphery slot, three lugs, a plurality of inner periphery recesses, a circular hole communicating with the periphery slot, and a threaded hole communicating with the periphery slot to match the circular hole. The screw rod is inserted through the threaded hole and the circular hole of the main body. The washer surrounds the screw rod. The butterfly nut engages with the screw rod.

### BRIEF DESCRIPTION OF THE DRAWINGS

FIG. 1 is a perspective assembly view of a tripod device of the prior art;

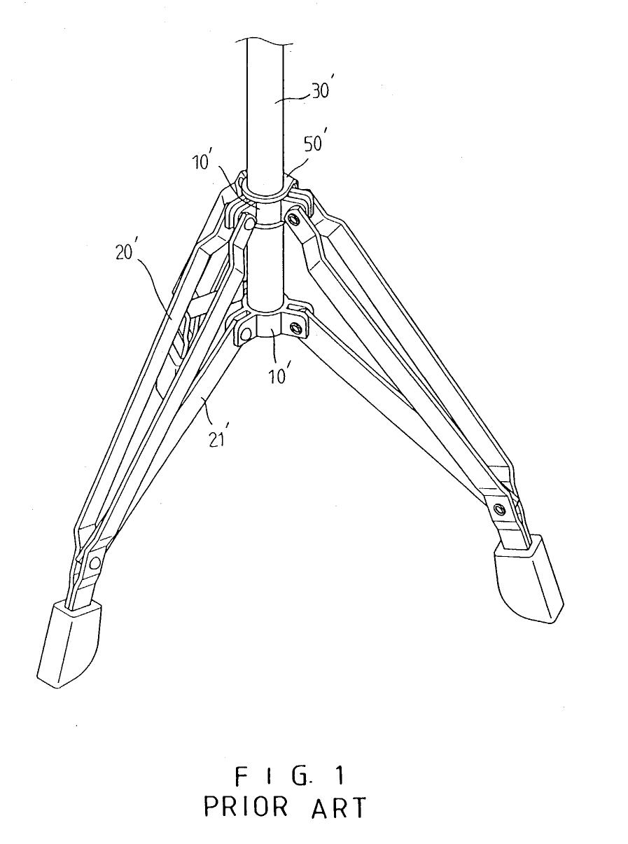

FIG. 2 is a perspective exploded view of a collar and a tripod joint of the prior art;

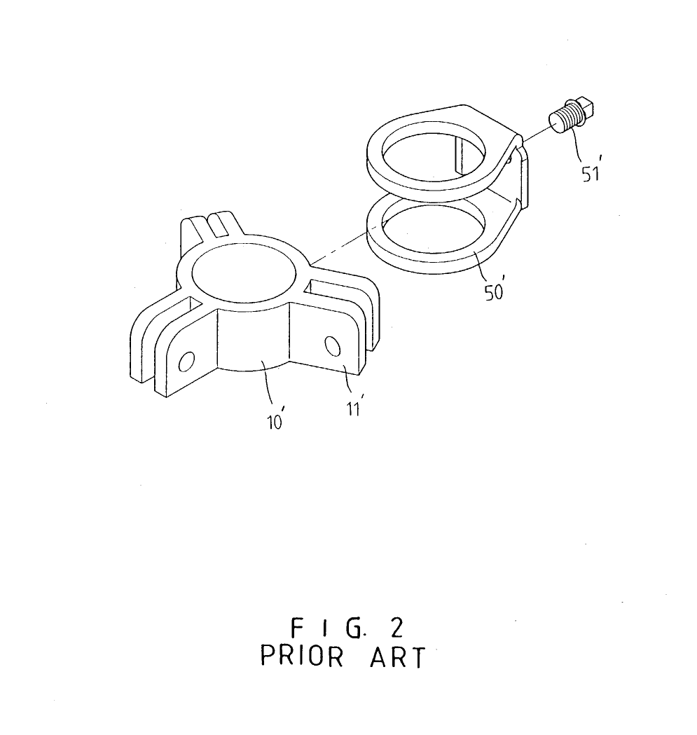

FIG. 3 is a perspective view of a main body of a tripod joint of a first preferred embodiment in accordance with the present invention;

FIG. 4 is a perspective exploded view of a tripod joint of a first preferred embodiment in accordance with the present invention;

FIG. 5 is a perspective view of a tripod joint of a second preferred embodiment in accordance with the present invention;

FIG. 6 is a perspective exploded view of a collar and a tripod joint of a third preferred embodiment in accordance with the present invention; and

FIG. 7 is a perspective exploded view of a collar and a tripod joint of a fourth preferred embodiment in accordance with the present invention.

### DETAILED DESCRIPTION OF THE INVENTION

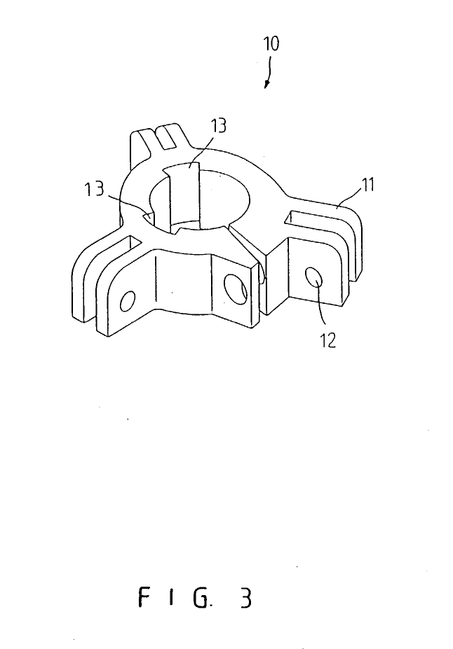

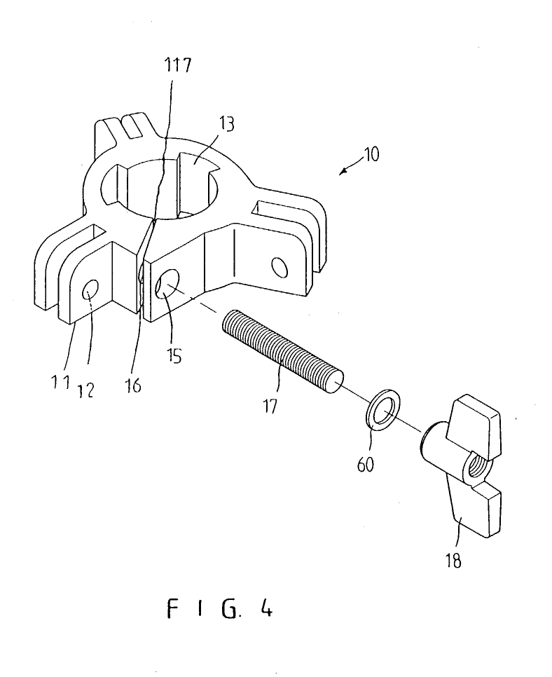

Referring to FIGS. 3 and 4, a first tripod joint comprises a main body 10, a screw rod 17, a washer 60, and a butterfly nut 18.

The main body 10 has a periphery slot 117, three lugs 11, a plurality of inner periphery recesses 13, a circular hole 15 communicating with the periphery slot 117, and a threaded hole 16 communicating with the periphery slot 117 to match the circular hole 15.

The screw rod 17 is inserted through the threaded hole 16 and the circular hole 15 of the main body 10.

The washer 60 surrounds the screw rod 17.

The butterfly nut 18 engages with the screw rod 17.

A diameter of the circular hole 15 of the main body 10 is larger than a diameter of the threaded hole 16 of the main body 10.

Each of the lugs 11 has a round hole 12.

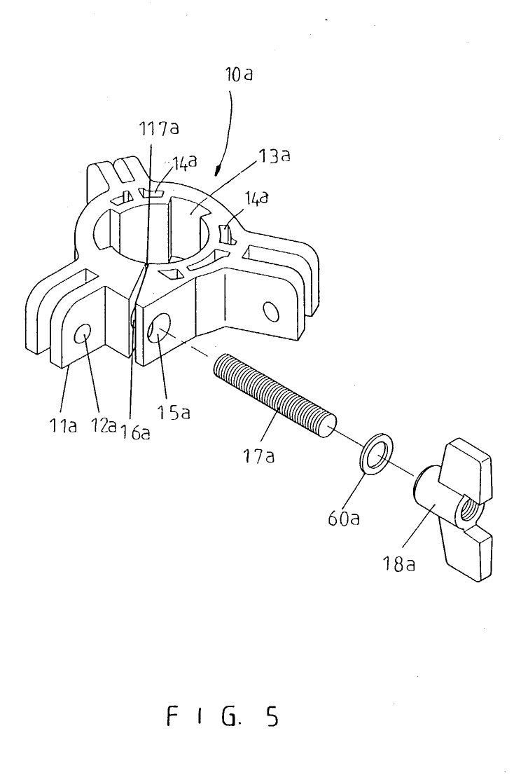

Referring to FIG. 5, a second tripod joint comprises a main body 10a, a screw rod 17a, a washer 60a, and a butterfly nut 18a.

The main body 10a has a periphery slot 117a, three lugs 11a, a plurality of inner periphery recesses 13a, a circular hole 15a communicating with the periphery slot 117a, a threaded hole 16a communicating with the periphery slot 117a to match the circular hole 15a, and a plurality of through holes 14a in order to increase an elasticity of the main body 10a.

The screw rod 17a is inserted through the threaded hole 16a and the circular hole 15a of the main body 10a.

The washer 60a surrounds the screw rod 17a.

The butterfly nut 18a engages with the screw rod 17a.

A diameter of the circular hole 15a of the main body 10a is larger than a diameter of the threaded hole 16a of the main body 10a.

Each of the lugs 11a has a round hole 12a.

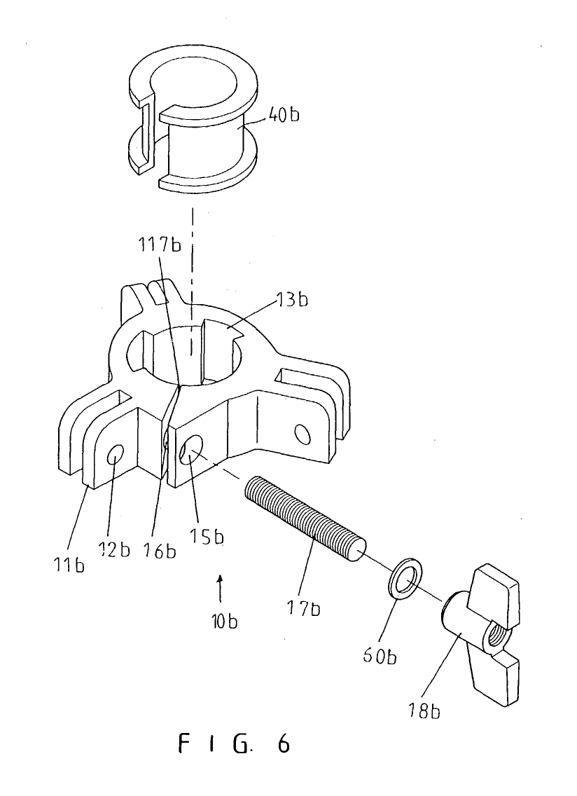

Referring to FIG. 6, a third tripod joint comprises a main body 10b, a screw rod 17b, a washer 60b, and a butterfly nut 18b.

The main body 10b has a periphery slot 117b, three lugs 11b, a plurality of inner periphery recesses 13b, a circular hole 15b communicating with the periphery slot 117b, and a threaded hole 16b communicating with the periphery slot 117b to match the circular hole 15b.

A collar 40b is inserted in the main body 10b.

The screw rod 17b is inserted through the threaded hole 16b and the circular hole 15b of the main body 10b.

The washer 60b surrounds the screw rod 17b.

The butterfly nut 18b engages with the screw rod 17b.

A diameter of the circular hole 15b of the main body 10b is larger than a diameter of the threaded hole 16b of the main body 10b.

Each of the lugs 11b has a round hole 12b.

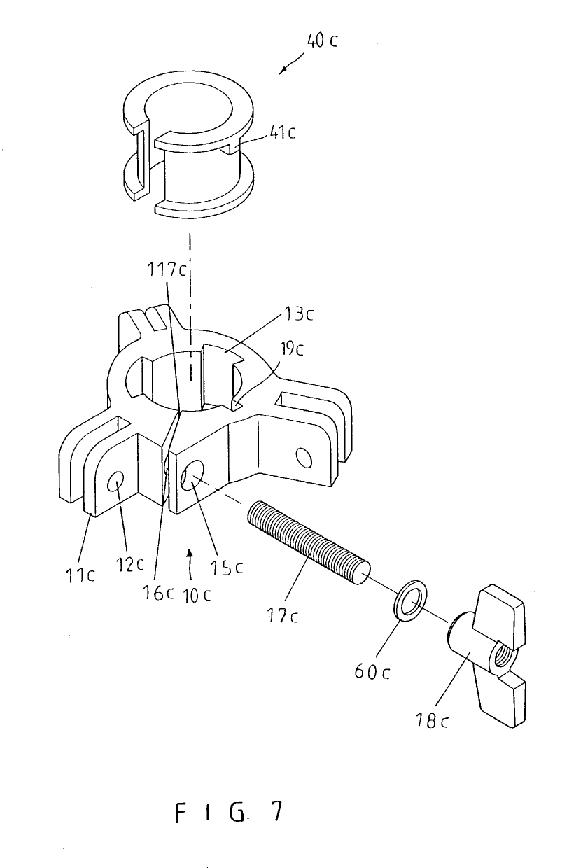

Referring to FIG. 7, a fourth tripod joint comprises a main body 10c, a screw rod 17c, a washer 60c, and a butterfly nut 18c.

The main body 10c has a periphery slot 117c, three lugs 11c, a plurality of inner periphery recesses 13c, a circular hole 15c communicating with the periphery slot 117c, and a threaded hole 16c communicating with the periphery slot 117c to match the circular hole 15c.

A collar 40c is inserted in the main body 10c.

The screw rod 17c is inserted through the threaded hole 16c and the circular hole 15c of the main body 10c.

The washer 60c surrounds the screw rod 17c.

The butterfly nut 18c engages with the screw rod 17c.

A diameter of the circular hole 15c of the main body 10c is larger than a diameter of the threaded hole 16c of the main body 10c.

Each of the lugs 11c has a round hole 12c.

The collar 40c has an outer protruded block 41c.

The main body 10c further has an inner groove 19c to receive the outer protruded block 41c of the collar 40c.

The invention is not limited to the above embodiment but various modification thereof may be made. Further, various changes in form and detail may be made without departing from the scope of the invention.

I claim:

1. A tripod joint comprises:
a main body, a screw rod, a washer, and a butterfly nut,
the main body having a periphery slot, three lugs, a plurality of inner periphery recesses, a circular hole communicating with the periphery slot, and a threaded hole communicating with the periphery slot to match the circular hole,
the screw rod inserted through the threaded hole and the circular hole of the main body,
the washer surrounding the screw rod, and
the butterfly nut engaging with the screw rod.

2. The tripod joint as claimed in claim 1, wherein a diameter of the circular hole of the main body is larger than a diameter of the threaded hole of the main body.

3. The tripod joint as claimed in claim 1, wherein the main body has a plurality of through holes.

4. The tripod joint as claimed in claim 1, wherein a collar is inserted in the main body.

5. The tripod joint as claimed in claim 4, wherein the collar has an outer protruded block, and the main body has an inner groove to receive the outer protruded block of the collar.
